(19) United States
(12) Patent Application Publication
(10) Pub. No.: US 2012/0047973 A1
(43) Pub. Date: Mar. 1, 2012

(54) LOCKOUT DEVICE

(75) Inventors: Davis Su, Guangzhou (CN); Ray Wojtak, Waterford, WI (US)

(73) Assignee: MASTER LOCK COMPANY LLC, Oak Creek, WI (US)

(21) Appl. No.: 13/218,959

(22) Filed: Aug. 26, 2011

Related U.S. Application Data
(60) Provisional application No. 61/377,495, filed on Aug. 27, 2010.
(60) Provisional application No. 61/416,801, filed on Nov. 24, 2010.

(51) Int. Cl. G05G 5/02

(52) U.S. Cl. 70/174

(57) ABSTRACT

A lockout device for a component extending from a component supporting structure includes a base member and a shell member. The base member defines an aperture sized to receive the component therethrough, and includes an outer flange portion that extends from the base member. The shell member includes first and second body members configured to be secured together with the base member in a first condition to block access to the component, and movable to a second condition to allow access to the component. At least one of the first and second body members includes an interlock portion received in an outer peripheral recess defined between the flange portion and a surface of one of the base member and the component supporting structure. The first and second members define a clasp portion configured to receive a locking component to secure the first and second body members in the first condition.

### CROSS-REFERENCE TO RELATED APPLICATIONS

This application claims priority to, and any other benefit of, U.S. Provisional Patent Application Ser. No. 61/377,495, entitled LOCKOUT DEVICE and filed Aug. 27, 2010, the entire disclosure of which is fully incorporated herein by reference. This application also claims priority to, and any other benefit of, U.S. Provisional Patent Application Ser. No. 61/416,801, entitled LOCKOUT DEVICE and filed Nov. 24, 2010, the entire disclosure of which is fully incorporated herein by reference.

### BACKGROUND

Automated devices, such as gas or electrically powered industrial equipment, are often provided with a control panel or interface including one or more buttons, knobs, switches, or other components for altering an operating condition of the equipment. For example, a machine may be provided with an emergency shutoff button or switch to immediately turn off the machine in the event of a serious malfunction or other emergency. In many cases, it may be desirable or necessary to temporarily prevent further operation of the component, for example, to maintain a shutoff condition. While a locking door, lid, or other such covering may be provided on a control panel to prevent access to the component for which access is to be restricted, such an obstruction may be undesirable where operation of one or more components on the control panel is still necessary during the lockout of one or more other components on the same control panel.

### SUMMARY

The present application describes lockout devices and methods for selectively blocking access to a component, such as, for example, a plunger-style button, extending from a component supporting structure, such as, for example, a control panel or other piece of equipment. According to one exemplary aspect of the present application, a lockout device for a component extending from a component supporting structure may include a base member that is affixed to the component supporting structure proximate to the component, and a shell member that interlocks with the base member and is movable to a first, component blocking or obstructing condition that prevents operation of the component.

Accordingly, in an exemplary embodiment, a lockout device for a component extending in an axial direction from a component supporting structure includes a base member and a shell member. The base member is configured to be affixed to the component supporting structure, and defines an aperture sized to receive the component therethrough. The base member includes an outer flange portion that extends in a lateral direction from the base member to define an outer peripheral recess between the flange portion and a surface of one of the base member and the component supporting structure when the base member is affixed to the component supporting structure. The shell member includes at least first and second body members configured to be secured together with the base member in a first condition to block access to the component when the base member is affixed to the component supporting structure. The first and second body members are movable with respect to each other to a second condition to allow access to the component. At least one of the first and second body members includes an interlock portion received in the outer peripheral recess at least when the shell member is secured with the base member in the first condition, thereby preventing axial separation of the shell member from the base member. The first and second members define a clasp portion configured to receive a locking component to secure the first and second body members in the first condition.

In another exemplary embodiment, a lockout device for a component extending in an axial direction from a component supporting structure includes a lockout base and a lockout shell. The lockout base is configured to be affixed to the component supporting structure, and includes a bottom-most apertured portion defining an aperture sized to receive the component therethrough, and an upper-most flanged portion including an outer peripheral flange that extends in a lateral direction from the base member to define an outer peripheral recess between the outer peripheral flange and an upper surface of one of the apertured portion and the component supporting structure when the base member is affixed to the component supporting structure. The lockout shell includes first and second body members attached at a hinged portion and including first and second interlock portions sized to be received in the outer peripheral recess when the shell member is secured with the base member in a pivoted closed position to block access to the component when the lockout base is affixed to the component supporting structure, thereby preventing axial separation of the shell member from the base member and blocking access to the component. The lockout shell is separable from the lockout base in a pivoted open position to allow access to the component. The first and second members define a clasp portion configured to receive a locking component to secure the first and second body members in the first condition.

In an exemplary method of restricting operation of a component extending in an axial direction from a component supporting structure, a base member is secured to the component supporting structure, such that the component extends through an aperture in the base member. An interlocking portion of a shell member is engaged with a recess defined between an outer peripheral flange of the base member and a surface of one of the base member and the component supporting structure, thereby preventing axial movement of the shell member with respect to the base member. First and second body members of the shell member are moved to a first condition in which access to the component is blocked. A locking component is engaged with a clasp portion of the first and second body members to prevent movement of the first and second body members out of the first condition.

### BRIEF DESCRIPTION OF THE DRAWINGS

Further features and advantages of the invention will become apparent from the following detailed description made with reference to the accompanying drawings, wherein:

FIG. 1 is a schematic cross-sectional view of a lockout device secured to a component on a control panel;

FIG. 2 is an upper perspective view of a lockout device, shown in an open, unlocked condition;

FIG. 3 is an upper perspective view of the lockout device of FIG. 2, shown in a closed condition;

FIG. 4 is a lower perspective view of the lockout device of FIG. 2, shown in the closed condition;

FIG. 5 is a side cross-sectional view of the lockout device of FIG. 2, shown in the closed condition;

FIG. 6 is an upper perspective view of the lockout base of the lockout device of FIG. 2;

FIG. 7A is a perspective view of a lockout device in a closed condition on a button on a control panel; and

FIG. 7B is a perspective view of the lockout device of FIG. 7A, shown in an open condition for removal from the button;

FIG. 8A is an upper perspective view of a lockout device, shown in an open, unlocked condition;

FIG. 8B is an upper perspective view of the lockout device of FIG. 8A, shown in a closed condition;

FIG. 9A is an upper perspective view of a lockout base that is adaptable for use with different sized components;

FIG. 9B is an upper perspective view of the lockout base of FIG. 9A assembled with a panel mounted component;

FIG. 9C is an upper perspective view of a lockout device partially installed on the lockout base of FIG. 9A;

FIG. 9D is an upper perspective view of the lockout base of FIG. 9A in an adapted condition;

FIG. 10A is a lower perspective view of a lockout base that is configured for installation on a component without removal of the component from a panel, and adaptable for use with different sized components;

FIG. 10B is an upper perspective view of the lockout base of FIG. 10A assembled with a panel mounted component;

FIG. 10C is an upper perspective view of a lockout device partially installed on the lockout base of FIG. 10A; and

FIG. 10D is a lower perspective view of the lockout base of FIG. 10A in an adapted condition.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meaning.

Also, while the detailed exemplary embodiments described in the specification and illustrated in the drawings relate to a hinged lockout device for a plunger-style button, it should be understood that many of the inventive features described herein may be applied to other types of lockout devices, including, for example, devices including lockout shells with sliding, telescoping, or separate, interlocking components, and for use with other types of components, including, for example, other control components (either alone or on a control panel), such as switches, knobs, keypads, valve handles, or other such components.

The present application contemplates, in part, a lockout device for a control component that blocks or restricts access to the component to prevent actuation or manipulation of the component. According to an aspect of the present application, a lockout device may be configured to block or restrict access to a component on a control panel while permitting access to one or more other components on the control panel. In one embodiment, a lockout base may be secured to a control panel around or otherwise proximate to a component to be locked out, for selective lockable coupling with a lockout shell, to block or restrict access to the component with the lockout shell. The lockout base may provide secure, interlocking retention of the lockout shell when the lockout shell is in a closed or lockout condition. Further, the lockout shell may be configured to be locked or secured in the closed or lockout condition to prevent decoupling of the lockout shell from the lockout base, either by an integrated locking mechanism (e.g., a key cylinder lock or combination lock mechanism) or by assembly with a lock (e.g., a padlock, cable lock, or pin lock).

FIG. 1 schematically illustrates an exemplary lockout device 10 secured to a component 20 on a component supporting structure 30 (e.g., a control panel), in accordance with an aspect of the present application. The lockout device 10 includes a lockout base 12 and a lockout shell 15. The lockout base 12 is secured to an opening 32 in the control panel 30 through which the component 20 extends. The lockout base 12 includes an apertured portion 11 sized to accommodate the component 20. The lockout base 12 may be secured to the control panel 30 using any suitable arrangement, including adhesive, fasteners, or welding, or may be integral to the control panel. In other embodiments, the apertured portion 11 of the lockout base 12 may be clamped between the control panel 30 and a portion of the component 20 to be locked out. In still other embodiments, the lockout base may be secured directly to a fixed base portion of the component, such that the lockout base is indirectly secured to the control panel.

The lockout base includes a shell interlock portion that interlocks with the lockout shell when the lockout shell is in a closed or lockout condition. The interlock portion may be provided with any structure sufficient to interlock with a base portion of the lockout shell to axially secure or fix the lockout shell on the lockout base to cover or obstruct at least a portion of the component to be locked out. As shown, the exemplary lockout base 12 includes a flanged interlock portion 13 that defines a recess 14 between the flange and the control panel 30. When the lockout shell 15 is assembled with the lockout base 12, an interlock portion 16 (e.g., a flange, lip, detent, or other feature) of the lockout shell is received in the recess 14, thereby axially fixing the lockout shell 15 to the lockout base 12, such that a barrier portion 18 securely covers or blocks the component 20, preventing access to or manipulation of the component.

To securely retain the interlock portion 16 of the lockout shell 15 in the recess 14, the lockout shell 15 may include two or more body members 17 that are secured together around the component 20, such that the interlock portion 16 is radially secured against withdrawal from the recess 14. These body members 17 may be movably connected to each other by hinges, sliding or telescoping engagement, or any other suitable arrangement. In other embodiments, the body members may be provided as two or more detached components held together by a lock or locking fastener. The body members 17 are configured to be locked together in interlocking engagement with the lockout base 12 using a locking component (schematically shown at 40) assembled with or otherwise engaging a clasp portion (schematically shown at 19) defined by the body members 17 to prevent manipulation of the component 20, for example, to achieve safe lockout of the component.

While a component lockout procedure may include assembling a lockout base with the control panel at the time that lockout of the component is to be conducted, in another aspect of the present application, the control panel may be preassembled or more permanently assembled with lockout bases associated with one or more components on the control panel. In such an arrangement, quick, convenient lockout of one or more components on the control panel 30 is facilitated, as the lockout shell 15 is merely assembled with the pre-installed lockout base 12 that corresponds to the component to be locked out. As shown, the lockout base 12 may be provided with a low profile structure that does not impede normal operation of the component 20, such that the lockout base 12 may be permanently assembled to the control panel 30. In one embodiment, a control panel having several control components may have a lockout base assembled around each component, such that any of the components may be selectively locked out as desired.

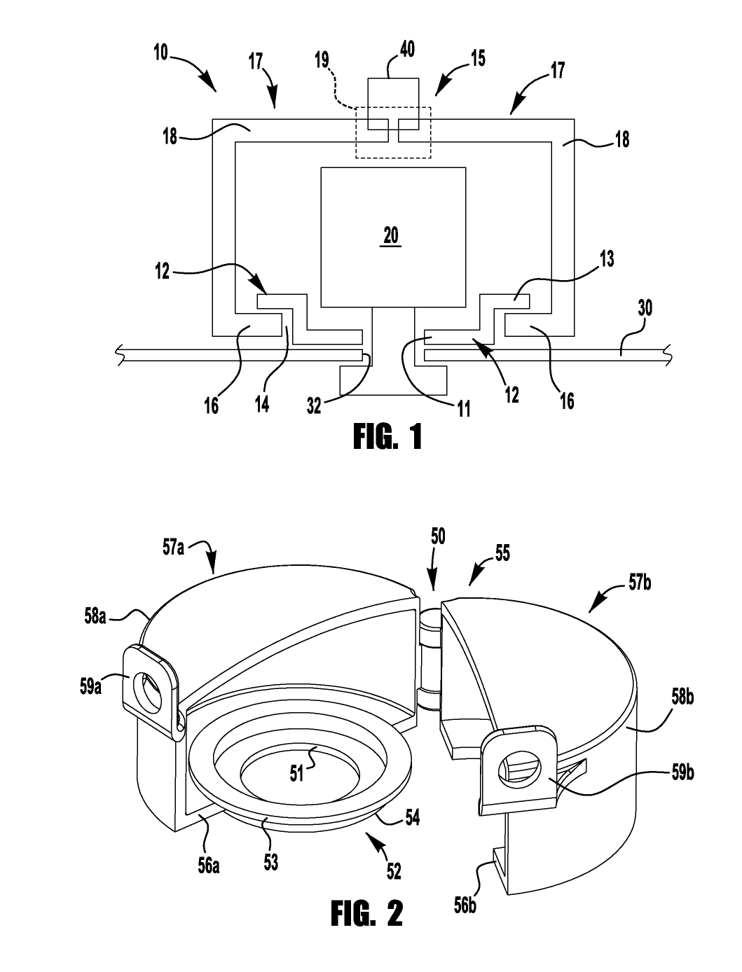

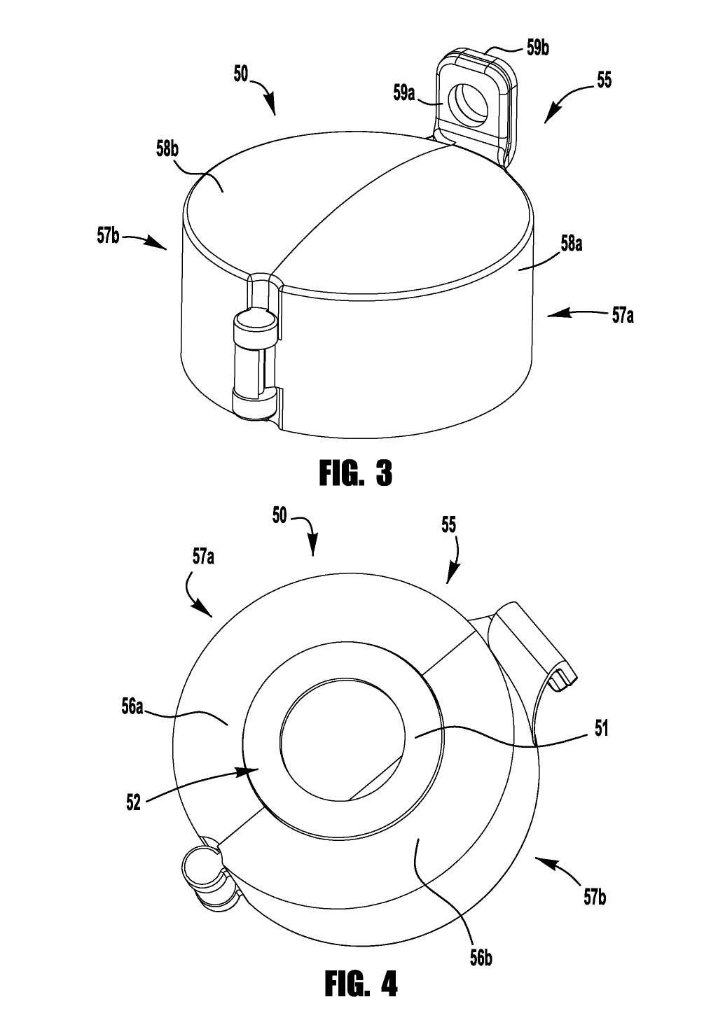

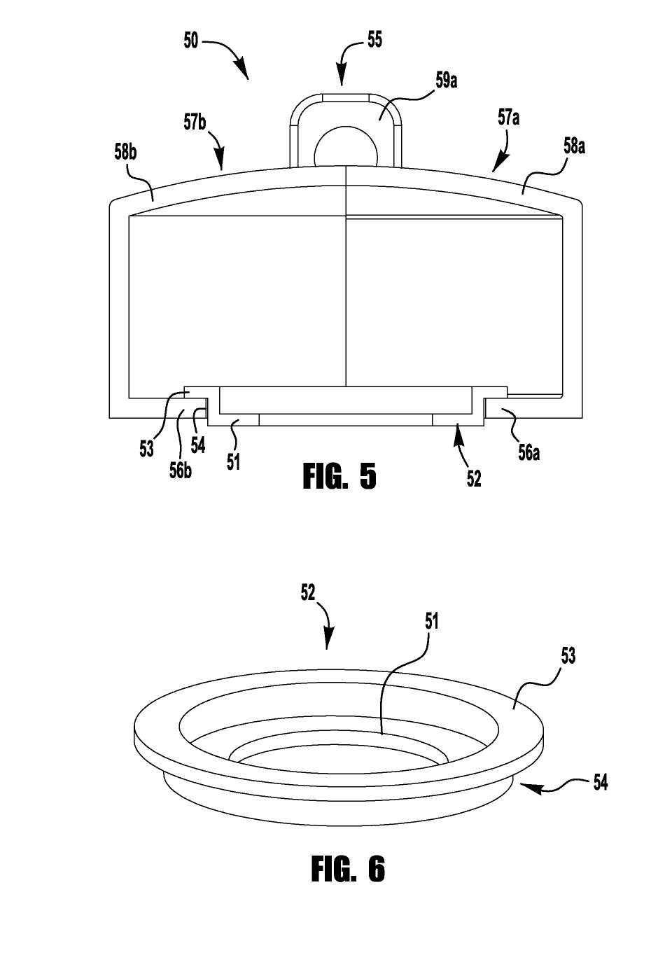

FIGS. 2-5 illustrate an exemplary lockout device 50 including a lockout base 52 and a lockout shell 55. The lockout shell 55 includes first and second body members 57a, 57b hinged together for movement between closed (or lockout) and open conditions. The body members 57a, 57b include flanges 56a, 56b sized to be received in a recess 54 beneath a flanged interlock portion 53 of the lockout base 52 when the lockout shell 55 is in the closed condition. Barrier portions 58a, 58b of the body members 57a, 57b cover or block the component with which the lockout device 50 is assembled. To lockingly secure the lockout shell 55 in the closed condition, the body members 57a, 57b are provided with hasp portions 59a, 59b that align when in the closed condition to receive a locking component (e.g., a padlock shackle, cable lock, or pin lock) therethrough.

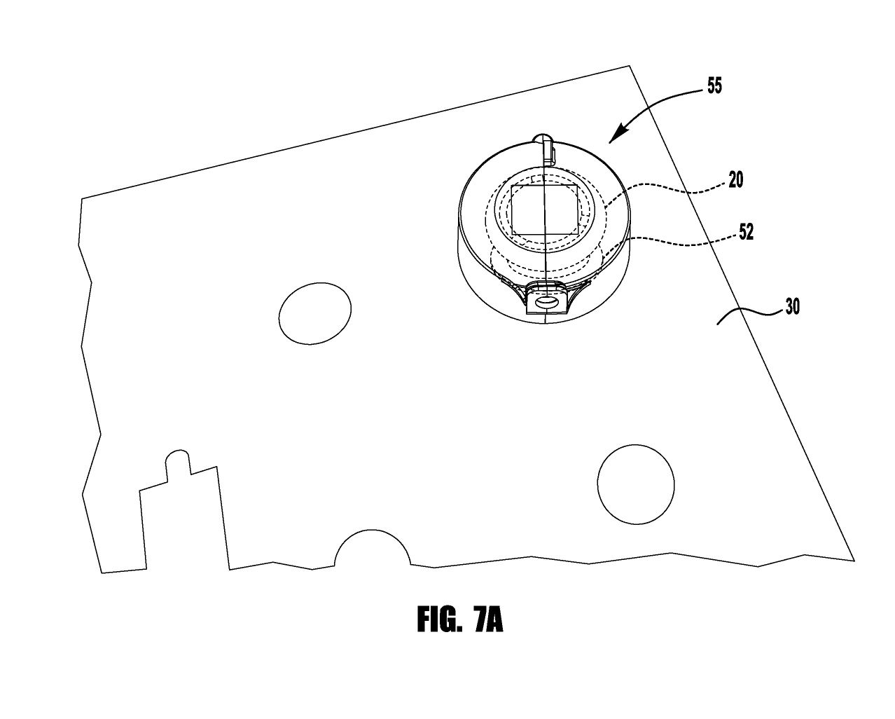

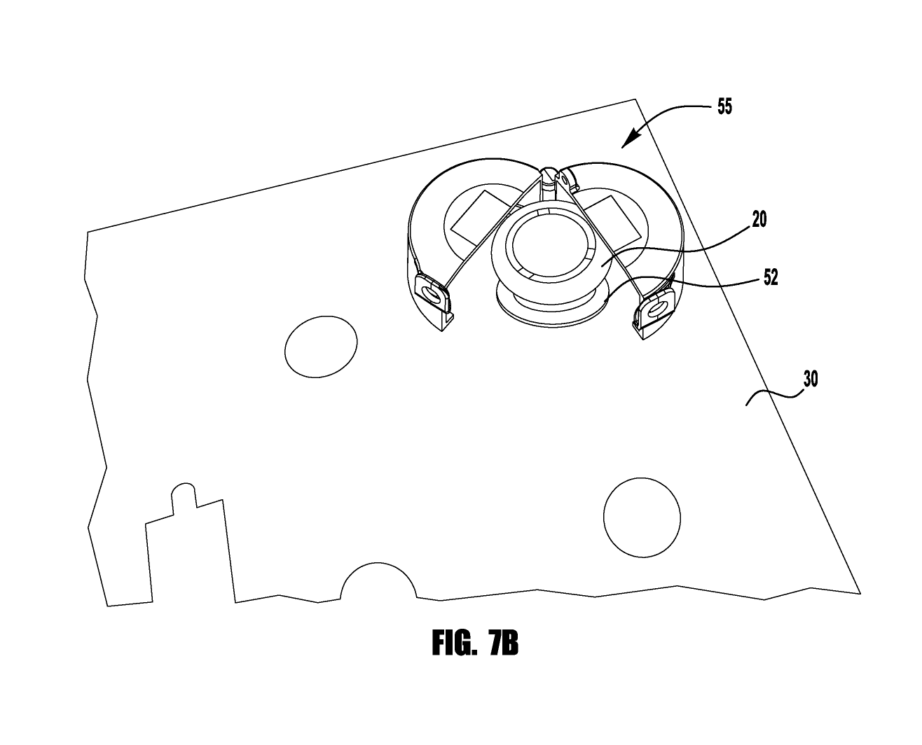

In an exemplary method of locking out a component 20 (for example, a plunger-style button, as shown in FIGS. 7A, 7B, 9B, and 10B) on a control panel 30 using the exemplary lockout device 50, an apertured portion 51 of the lockout base 52 is clamped between the component and the control panel around the opening in the control panel through which the button is installed. The body members 57a, 57b are positioned around the lockout base 52 in the lockout shell's opening condition. The body members 57a, 57b are then pivoted to the closed or lockout condition on the lockout base 52, such that the flanges 56a, 56b are received in the recess 54 beneath the flanged interlock portion 53 of the lockout base 52. A locking component, such as a padlock shackle, may be locked through the aligned hasp portions 59a, 59b of the body members 57a, 57b to secure the lockout shell 55 in the lockout condition. As a result, the lockout shell 55 is axially secured to the lockout base 52, such that the barrier portions 58a, 58b of the body members 57a, 57b cover the button to prevent access to or manipulation of the button. To remove the lockout device 50, the locking component is removed from the hasp portions 59a, 59b and the body members 57a, 57b are pivoted outward to an open condition for removal of the lockout shell 55, thereby exposing the component for operation as desired (see FIG. 7B).

Many other types of lockout devices may be configured for assembly with a ring-shaped lockout base, such as the lockout bases described herein. In one embodiment, a lockout device may be configured for more permanent attachment to a control panel. For example, as shown in FIGS. 8A and 8B, a lockout device 80 may include a bottom bracket 81 securable to a control panel and a cover member 82 hingedly secured to the bottom bracket 81 at rear wall portions 83a, 83b of the cover member and bottom bracket for pivoting between an open, component accessing position (FIG. 8A), and a closed, component blocking position (FIG. 8B). The exemplary cover member 82 includes opposed side walls 87 to block access to the sides of the locked out component, and a top wall 86 oriented to block access to the top of the locked out component. The bottom bracket 81 may be apertured to be secured to the control panel using a lockout base (for example, a lockout base consistent with one of the exemplary lockout bases described herein). Alternatively, as shown in the illustrated embodiment, the bottom bracket 81 may include an integrally formed base portion 89 defining an aperture 85 sized for direct assembly with the control panel. A hasp 84b (or other lock aperture defining portion) extending from an axially extending front wall of the bottom bracket 81 is aligned with a hasp 84a (or other lock aperture defining portion) of the cover member 82 when the cover member is in the closed position, such that insertion of a padlock shackle (not shown) or other locking member through the hasps 84a, 84b secures the cover member 82 in the closed, component blocking position. In another embodiment (not shown), only one of the bottom bracket and cover member may include a lock aperture, with a portion of the other of the bottom bracket and cover member abutting a locking member inserted through the lock aperture to prevent pivoting of the cover member to the open position. Because the bottom bracket 81 is integral with the base portion 89 (or alternatively, fully surrounds a lockout base to which the bottom bracket is secured, the illustrated lockout device 80 may be more permanently secured to the component and control panel (for example, as compared to the hinged lockout device 50 of FIGS. 2-5).

According to another aspect of the present application, a lockout base for a lockout device may be configured to be adaptable for use with components (e.g., buttons) of multiple sizes. In one embodiment, a lockout base includes an apertured portion with one or more frangible portions defining a first, smaller diameter aperture for use with a smaller component. The frangible portions may be manually broken off or otherwise removed to define a second, larger diameter aperture for use with a larger component. The frangible portions may be provided, for example, as any number of tabs or a full ring of material.

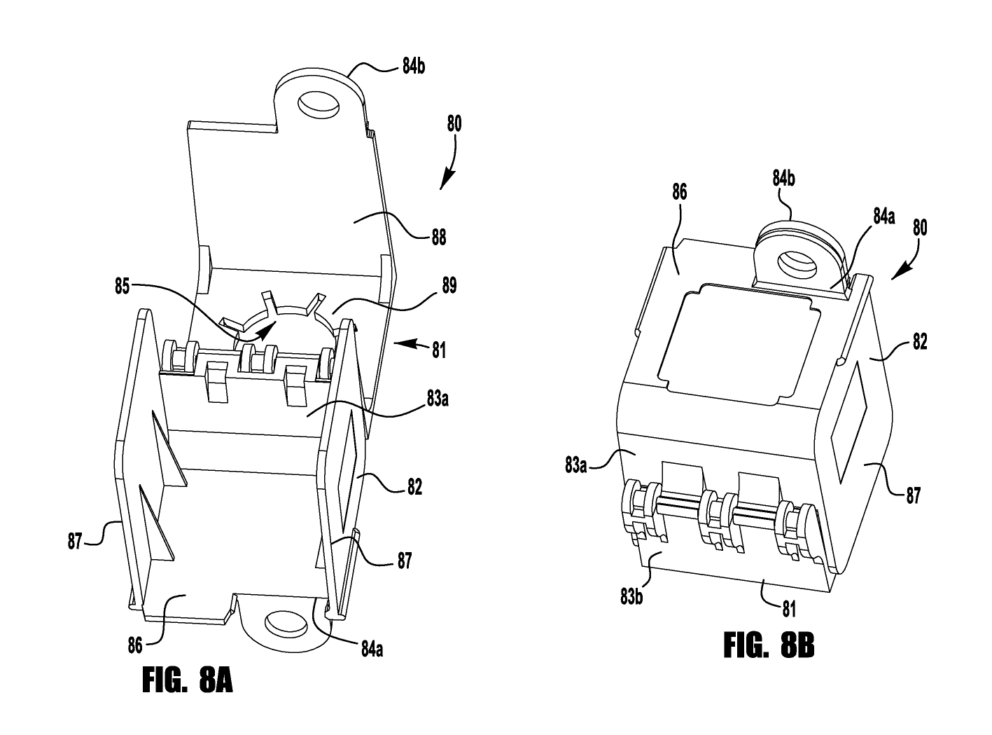

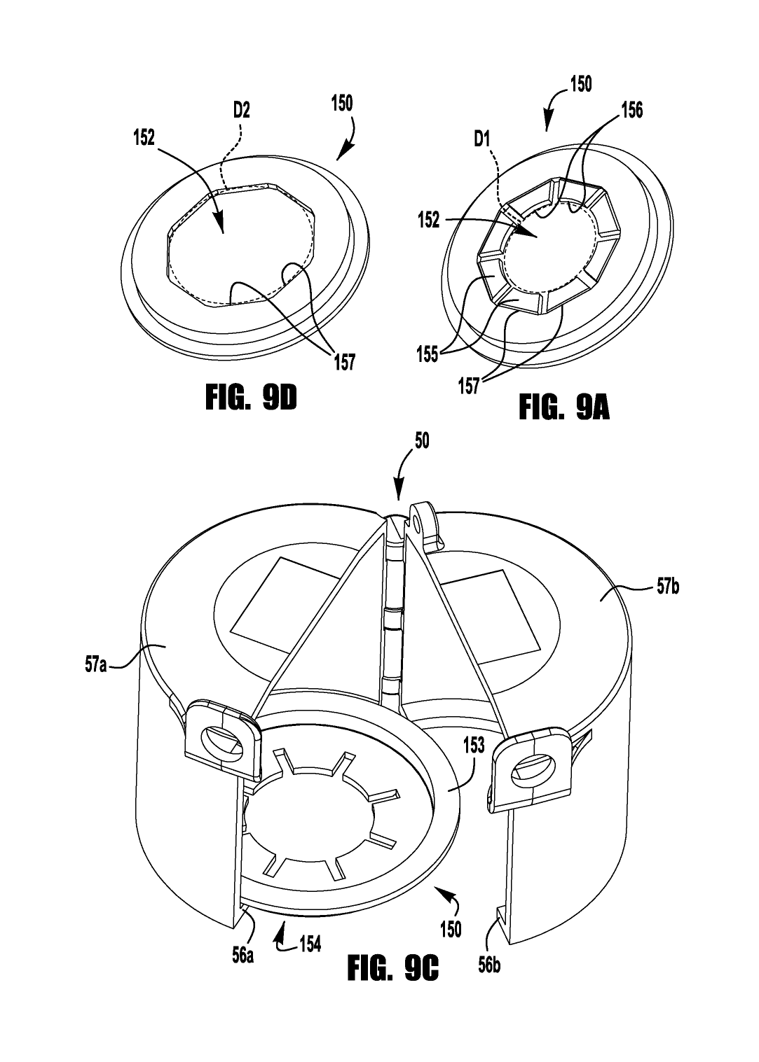

FIGS. 9A-9D illustrate an exemplary adaptable lockout base 150 having an apertured portion 152 with frangible tabs 155 (shown in FIG. 9A) that define a smaller first aperture diameter D1, for installation with a smaller diameter component (e.g., a button assembly having a 22 mm diameter). During installation, outer edges 156 (FIG. 9A) of the tabs 155 may be clamped under (or otherwise engage) an outer diameter of a component 120, as shown in FIG. 9B, to center the component within the base 150. As shown in FIG. 9C, flanges 56a, 56b of body halves 57a, 57b of a lockout device 50 may be received in a recess 154 beneath a flanged portion 153 of the base 150, consistent with the exemplary lockout method described in greater detail above.

When the tabs 155 are broken off of the base 150, the apertured portion 152 of the lockout base defines a larger second aperture diameter D2 for installation with a larger diameter component (e.g., a button assembly having a 30 mm diameter), as shown in FIG. 9D. To facilitate manual user removal of the tabs 155, a root portion 157 of the tabs may be scored or perforated, such that the tabs break along this scoring or perforation. In one embodiment, a bottom surface of the tabs 155 is scored, such that a downward force on the tabs (consistent with pulling up on an installed lockout device) is less likely to deform or break the tabs 155. During installation, the sheared root portions 157 may engage an outer diameter of the component to center the component within the base 150. In other embodiments (not shown), the frangible portion(s) of the base may be provided with tabs of varying lengths, or with multiple score lines or perforations at varying diameters to provide for three or more possible aperture diameters.

According to still another aspect of the present application, a lockout base may be provided for field retrofit with an already installed component, so that the component does not have to be disassembled from a control panel for installation of the lockout device. In one embodiment, a lockout base is provided as a partial ring sized to be slid under one side of the component. Any suitable mechanism may be utilized to secure the partial ring lockout base to the control panel, including, for example, mechanical fasteners, glue or two-sided tape. The partial ring lockout base includes an outer peripheral groove sized to extend around a sufficient portion of the component for secure attachment of the lockout device.

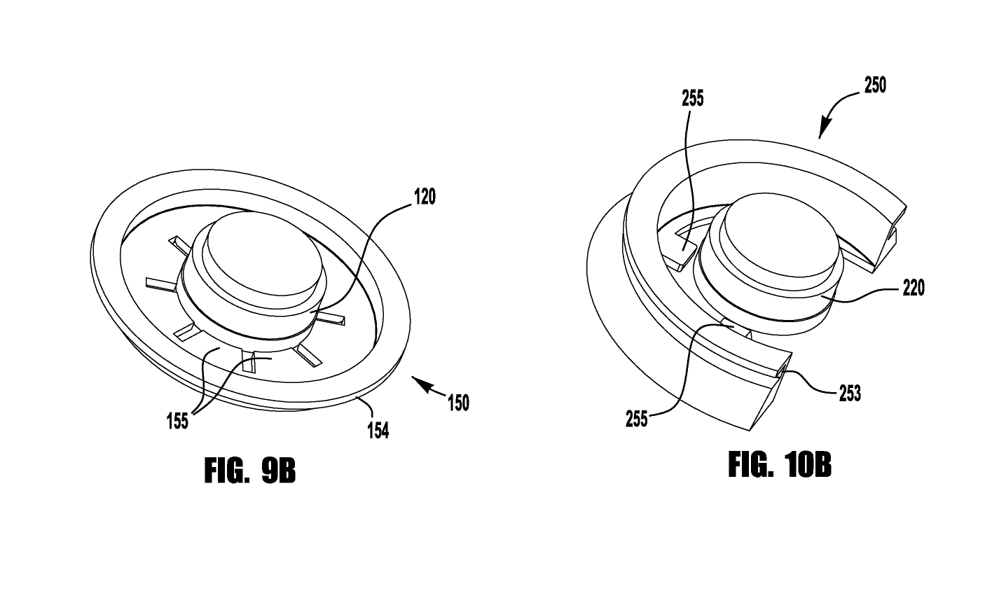

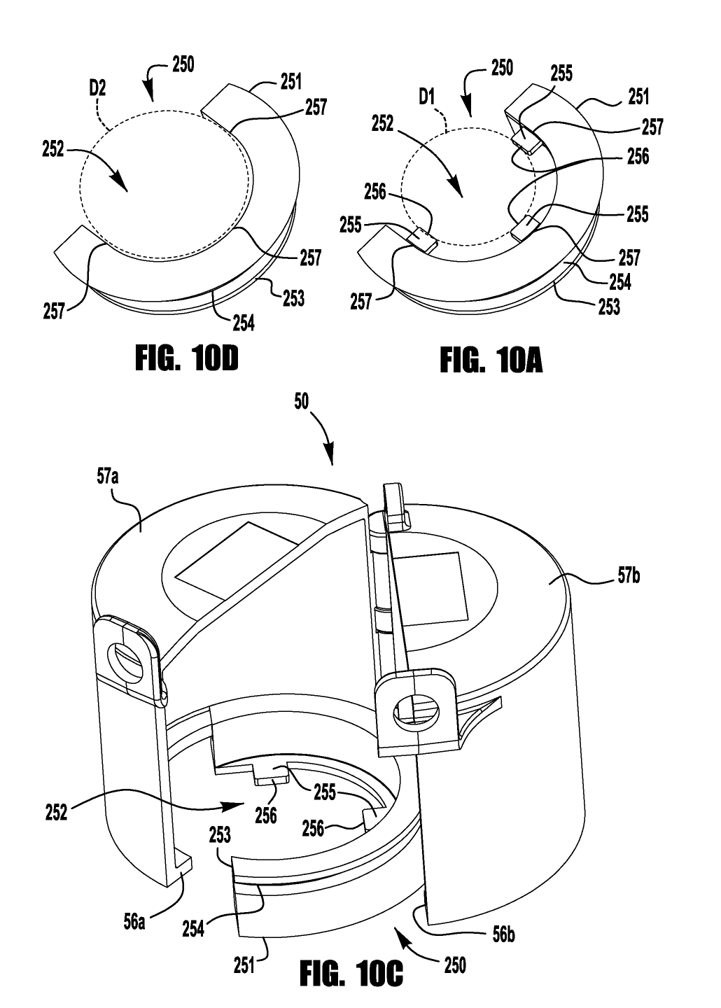

FIGS. 10A-10D illustrate an exemplary partial ring or U-shaped lockout base 250 having an open apertured portion 252 sized to receive a base portion of a component 220 therein, as shown in FIG. 10B, with the component remaining installed on a control panel. The lockout base 250 includes a lower flange 251 and an upper flange 253 defining a recessed portion or groove 254 sized to receive a sufficient portion of interlocking flanges 56a, 56b of a lockout device 50 to secure the lockout device on the lockout base (see FIG. 10C) when the device is secured in a closed or lockout condition. The lower flange 251 may be secured to the control panel around the base of the component 220 using an adhesive or other such fastener.

As with the lockout base 150 of FIGS. 9A and 9B, the partial ring lockout base 250 may be provided with frangible tabs 255 (shown in FIG. 10A) that define a smaller first aperture diameter D1, for installation with a smaller diameter component (e.g., a button assembly having a 22 mm diameter). During installation, outer edges 256 of the tabs 255 may engage an outer diameter of the component 220 to center the component within the base 250. When these tabs 255 are broken off of the base 250, the apertured portion 252 of the lockout base defines a larger second aperture diameter D2 for installation with a larger diameter component (e.g., a button assembly having a 30 mm diameter), as shown in FIG. 10D. To facilitate manual user removal of the tabs 255, a root portion 257 of the tabs may be scored or perforated, such that the tabs break along this scoring or perforation. In one embodiment, a bottom surface of the tabs 255 is scored, such that a downward force on the tabs (consistent with pulling up on an installed lockout device) is less likely to deform or break the tabs 255. During installation, the sheared root portions 257 may engage an outer diameter of the component to center the component within the base 250. In other embodiments (not shown), the frangible portion(s) of the base may be provided with tabs of varying lengths, or with multiple score lines or perforations at varying diameters to provide for three or more possible aperture diameters.

While the lockout device components may be provided in any suitable material, in one embodiment, the body members are provided in a clear plastic material, such that the condition of the locked out button is visible. This may be useful, for example, when used with buttons having visibly evident pressed and un-pressed conditions, such as, for example, a conventional push-pull/twist button.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lockout device for a component extending in an axial direction from a component supporting structure, the lockout device comprising:
a base member configured to be affixed to the component supporting structure, the base member defining an aperture sized to receive the component therethrough, and including an outer flange portion that extends in a lateral direction from the base member to define an outer peripheral recess between the flange portion and a surface of one of the base member and the component supporting structure when the base member is affixed to the component supporting structure; and
a shell member comprising at least first and second body members configured to be secured together with the base member in a first condition to block access to the component when the base member is affixed to the component supporting structure, the first and second body members being movable with respect to each other to a second condition to allow access to the component;
wherein at least one of the first and second body members includes an interlock portion received in the outer peripheral recess at least when the shell member is secured with the base member in the first condition, thereby preventing axial separation of the shell member from the base member;
further wherein the first and second members define a clasp portion configured to receive a locking component to secure the first and second body members in the first condition.

2. The device of claim 1, wherein the interlock portion is retained in the outer peripheral recess when the first and second body members are in the second condition.

3. The device of claim 1, wherein the interlock portion is separable from the outer peripheral recess when the first and second body members are in the second condition.

4. The device of claim 1, wherein the first and second body members are pivotable between the first and second conditions.

5. The device of claim 1, wherein the first and second body members are pivotable about an axis extending axially when the shell member is assembled with the base member.

6. The device of claim 1, wherein the first and second body members are pivotable about an axis extending laterally when the shell member is assembled with the base member.

7. The device of claim 1, wherein the clasp portion comprises a hasp portion extending from at least one of the first and second body member.

8. The device of claim 1, wherein the base member comprises a ring-shaped member.

9. The device of claim 1, wherein the base member aperture is at least partially defined by a frangible inner portion, such that the base member defines a second, larger aperture upon separation of the frangible inner portion from the base member.

10. The device of claim 1, wherein the base member forms a partial ring shape.

11. A method of restricting operation of a component extending in an axial direction from a component supporting structure, comprising:
securing a base member to the component supporting structure, such that the component extends through an aperture in the base member;
engaging an interlocking portion of a shell member with a recess defined between an outer peripheral flange of the base member and a surface of one of the base member and the component supporting structure, thereby preventing axial movement of the shell member with respect to the base member;
moving first and second body members of the shell member to a first condition in which access to the component is blocked; and
engaging a locking component with a clasp portion of the first and second body members to prevent movement of the first and second body members out of the first condition.

12. The method of claim 11, further comprising separating a frangible inner portion from the base member to size the aperture to accommodate the component.

13. The method of claim 11, wherein moving the first and second body members of the shell member to the first condition comprises pivoting the second body member with respect to the first body member.

14. The method of claim 13, wherein pivoting the second body member with respect to the first body member comprises pivoting the second body member about a hinge portion that extends in an axial direction.

15. The method of claim 13, wherein pivoting the second body member with respect to the first body member comprises pivoting the second body member about a hinge portion that extends in a lateral direction.

16. The method of claim 11, wherein engaging a locking component with a clasp portion of the first and second body members comprises inserting a padlock shackle through a hasp portion of at least one of the first and second body members.

17. The method of claim 11, wherein securing the base member to the component supporting structure comprises clamping the base member between the component and the component supporting structure.

18. A lockout device for a component extending in an axial direction from a component supporting structure, the lockout device comprising:
a lockout base configured to be affixed to the component supporting structure, the lockout base including a bottom-most apertured portion defining an aperture sized to receive the component therethrough, and an upper-most flanged portion including an outer peripheral flange that extends in a lateral direction from the base member to define an outer peripheral recess between the outer peripheral flange and an upper surface of one of the apertured portion and the component supporting structure when the base member is affixed to the component supporting structure; and
a lockout shell comprising first and second body members attached at a hinged portion and including first and second interlock portions sized to be received in the outer peripheral recess when the shell member is secured with the base member in a pivoted closed position to block access to the component when the lockout base is affixed to the component supporting structure, thereby preventing axial separation of the shell member from the base member and blocking access to the component, the lockout shell being separable from the lockout base in a pivoted open position to allow access to the component;
wherein the first and second members define a clasp portion configured to receive a locking component to secure the first and second body members in the first condition.

19. The lockout device of claim 18, wherein the lockout base comprises a ring-shaped member.

20. The lockout device of claim 18, wherein the lockout base comprises a partial ring-shaped member.

21. The lockout device of claim 18, wherein the outer peripheral recess of the lockout base comprises a groove between the outer peripheral flange and a second flange extending from the aperture portion.

22. A lockout device for a component extending in an axial direction from a component supporting structure, the lockout device comprising:
a bottom bracket including a base portion defining an aperture for receiving the component therethrough and a first wall extending in an axial direction from the base portion, the first wall defining a lock aperture; and
a cover member hingedly secured to the bottom bracket for pivoting between an open, component accessing position and a closed, component blocking position;
wherein when the cover member is pivoted to the closed position, insertion of a locking member through the lock aperture prevents pivoting movement of the cover member to the open position.
